(19) United States
(12) Patent Application Publication
(10) Pub. No.: US 2026/0141612 A1
(43) Pub. Date: May 21, 2026

(54) SIGNALING MECHANISMS FOR VIEWPOINT-DEPENDENT RENDERING

(71) Applicant: FRAUNHOFER-GESELLSCHAFT ZUR FÖRDERUNG DER ANGEWANDTEN FORSCHUNG E.V., München (DE)

(72) Inventors: Yago SANCHEZ DE LA FUENTE, Berlin (DE); Sergio Tejeda Pastor, Berlin (DE); Robert Skupin, Berlin (DE); Cornelius Hellge, Berlin (DE); Thomas Schierl, Berlin (DE); Thomas Wiegand, Berlin (DE); Fangwen Shu, Berlin (DE); Soonbin Lee, Berlin (DE)

(21) Appl. No.: 19/451,368

(22) Filed: Jan. 16, 2026

Related U.S. Application Data
(63) Continuation of application No. PCT/EP2024/070433, filed on Jul. 18, 2024.

(30) Foreign Application Priority Data
Jul. 18, 2023 (EP) 23186254.1

(51) Int. Cl. G06T 15/00; G06F 40/205

(52) U.S. Cl. CPC G06T 15/00; G06F 40/205

(57) ABSTRACT

This invention concerns a method for viewpoint-dependent rendering of a 3D object inside a scene. The method has a step of parsing rendering information from a scene description document, and a step of selecting one neural network out of a plurality of pre-trained neural networks for rendering the 3D object, wherein the pre-trained neural networks are each trained for rendering the 3D object with different viewpoint-dependent representation qualities, wherein each neural network has one or more main viewpoints from where the 3D object is rendered with a highest representation quality, wherein the rendering information indicates the respective main viewpoint belonging to each neural network.

### CROSS-REFERENCE TO RELATED APPLICATIONS

This application is a continuation of copending International Application No. PCT/EP2024/070433, filed Jul. 18, 2024, which is incorporated herein by reference in its entirety, and additionally claims priority from European Application No. 23186254.1, filed Jul. 18, 2023, which is also incorporated herein by reference in its entirety.

### TECHNICAL FIELD

In this document, different embodiments and aspects will be described regarding the introduction of a signaling mechanism to select the appropriate view of a 3D element in a scene, based on the relative position and orientation of the object relative to the camera (user), and using a Neural Network (NN) for rendering the 3D element in which the quality of the representation is emphasized/enhanced for the specific view (or viewing position) around the element.

Accordingly, embodiments of the present disclosure are concerned with a method for viewpoint-dependent rendering of a 3D object inside a scene, as well as to a corresponding device. Further embodiments of the present disclosure relate to a method for real-time viewpoint-dependent rendering of a 3D object and a corresponding device.

### BACKGROUND OF THE INVENTION

The invention is located in the technical field of rendering 3D objects in 2D novel views, such as volumetric video synthesis for virtual reality/augmented reality (VR/AR) applications, where neural networks (NNs) are utilized for rendering a particular 3D object or scene.

As an example for a neural network based rendering concept, NeRF (Neural Radiance Field) can be mentioned, wherein a neural network is trained with a sparse set of 2D images taken around the 3D object. The input of the neural network is a single continuous 5D coordinate comprising the user's spatial location (x, y, z) and viewing direction (θ, φ). The output of the neural network is the volume density and view-dependent emitted radiance at that spatial location. This output can be used for creating/synthesizing new 2D images of the 3D object, which were not present before. These new 2D images may also be referred to as novel views. When combining the 2D images with the 2D novel views, the 3D object can be fully rendered even though the originally available sparse set of 2D images only contained a few views of the 3D object.

However, these rendering techniques need a large amount of computing resources. Thus, the rendering of a 3D object takes a lot of time and it may be very challenging for the processing computer. Accordingly, a fast or even real-time rendering is very hard to realize, if at all, and such rendering techniques are only realizable with highly evolved computers which cost a lot of money.

Thus, it is an object of the present invention to enhance existing rendering techniques to enable a fast and affordable (in terms of resources and money) rendering of a 3D object.

### SUMMARY

According to an embodiment, an apparatus to be used in a viewpoint-dependent rendering of a 3D object in a scene, may have: a file parser configured to parse rendering information from a scene description document, wherein the apparatus is configured to select one neural network out of a plurality of pre-trained neural networks for rendering the 3D object, wherein the pre-trained neural networks are each trained for rendering the 3D object with different viewpoint-dependent representation qualities, wherein each neural network comprises at least one main viewpoint from where the 3D object is rendered with a highest representation quality, wherein the rendering information indicates the respective main viewpoint belonging to each neural network, and wherein the selection of the one neural network is based on a current viewpoint of a user device, said current viewpoint being defined as a position and/or orientation from where the user device currently looks at the 3D object.

According to a first aspect, a method for viewpoint-dependent rendering of a 3D object inside a scene is suggested. The method comprises a step of parsing rendering information from a scene description document, and a step of selecting one neural network out of a plurality of pre-trained neural networks for rendering the 3D object, wherein the pre-trained neural networks are each trained for rendering the 3D object with different viewpoint-dependent representation qualities, wherein each neural network comprises one or more main viewpoints from where the 3D object is rendered with a highest representation quality, wherein the rendering information indicates the respective main viewpoint belonging to each neural network.

In accordance with the first aspect, a corresponding apparatus (e.g. a system comprising, or being configured as, at least one of a user/client device and a NN provider/server) to be used in viewpoint-dependent rendering of a 3D object inside a scene is suggested. The apparatus comprises a file parser configured to parse rendering information from a scene description document. The apparatus is further configured to select one neural network out of a plurality of pre-trained neural networks for rendering the 3D object, wherein the pre-trained neural networks are each trained for rendering the 3D object with different viewpoint-dependent representation qualities, wherein each neural network comprises one or more main viewpoints from where the 3D object is rendered with a highest representation quality, wherein the rendering information indicates the respective main viewpoint belonging to each neural network.

According to a second aspect, a method for real-time viewpoint-dependent rendering of a 3D object is suggested. The method comprises a step of determining a viewpoint of a user device, wherein said viewpoint may change over time, wherein the viewpoint is defined as a position and/or orientation from where the user device looks at the 3D object to be rendered. The method further comprises a step of using an updatable dynamic neural network for rendering the 3D object with different viewpoint-dependent representation qualities depending on the current viewpoint of the user device, wherein the dynamic neural network comprises one or more main viewpoints from where the 3D object is rendered with a highest representation quality. According to this aspect of the invention, the dynamic neural network is configured to be updated in order to provide new one or more main viewpoints between two consecutive time instants.

In accordance with the second aspect, a corresponding apparatus (e.g. a system comprising a user device that may be configured as a receiver for receiving updated NNs and a neural network generator/sender/server) is suggested. The apparatus is configured to determine a viewpoint of a user device, wherein said viewpoint may change over time, wherein the viewpoint is defined as a position and/or orientation from where the user device looks at the 3D object to be rendered. The apparatus is further configured to use an updatable dynamic neural network for rendering the 3D object with different viewpoint-dependent representation qualities depending on the current viewpoint of the user device, wherein the dynamic neural network comprises one or more main viewpoints from where the 3D object is rendered with a highest representation quality. According to this aspect of the invention, the dynamic neural network is configured to be updated in order to provide new one or more main viewpoints between two consecutive time instants.

According to a further aspect, computer programs are provided, wherein each of the computer programs is configured to implement the above-described methods when being executed on a computer or signal processor, so that the above-described method is implemented by one of the computer programs.

### BRIEF DESCRIPTION OF THE DRAWINGS

In the following, embodiments of the present disclosure are described in more detail with reference to the figures, in which:

FIG. 1 shows a schematic diagram of inputs and outputs of a neural network based rendering technique, wherein NeRF is taken as an example;

FIG. 2a shows a schematic diagram of training neural networks with a weighting function according to an embodiment;

FIG. 2b shows a schematic diagram of signaling the neural networks to a user device according to an embodiment;

FIG. 2c shows a schematic diagram of determining a relative position between the user device and a 3D object according to an embodiment;

FIG. 2d shows a schematic diagram of selecting a neural network with a main viewpoint being closest to a current viewpoint of the user device according to an embodiment;

FIG. 3 shows a schematic diagram of a weighting mechanism being applied to a neural network based rendering technique according to an embodiment;

FIG. 4 shows different weighting curves according to an embodiment;

FIG. 5 shows different coordinate systems for the user device and the 3D object to be rendered;

FIG. 6 shows a schematic diagram of a change in the main viewpoint when the user device moves in accordance with an embodiment;

FIG. 7 shows a schematic diagram of a viewpoint-dependent streaming architecture according to an embodiment;

FIG. 8 shows a schematic diagram of signaling viewpoint segment over time with gITF format according to an embodiment;

FIG. 9 shows a schematic diagram of a coordinate system as defined in gITF; and

FIG. 10 shows a schematic diagram of a real-time feedback scenario according to an embodiment.

### DETAILED DESCRIPTION OF THE INVENTION

Equal or equivalent elements or elements with equal or equivalent functionality are denoted in the following description by equal or equivalent reference numerals.

Method steps which are depicted by means of a block diagram and which are described with reference to said block diagram may also be executed in an order different from the depicted and/or described order. Furthermore, method steps concerning a particular feature of a device may be replaceable with said feature of said device, and the other way around. Embodiments of the present invention refer to the signaling mechanisms that allow a 3D object to be rendered with the highest possible quality depending on the relative position between the object and the camera, also referred to in the following as viewing direction/position.

In the following description, the so-called NeRF (Neural Radiance Fields) technique is described as one non-limiting example for a neural network based rendering of 3D objects. It is contemplated that the herein disclosed invention may be used with NeRF or any other neural network based rendering techniques.

### BACKGROUND

When creating and rendering immersive applications, different techniques have been commonly applied in the past in order to guarantee that the rendered view of an object that is presented to the user has the highest possible quality, while lower resources are dedicated to the parts that are not visible or have less importance. For instance, in 360-degree video streaming, the content corresponding to the user viewport has been transmitted at high resolution, while the rest has been transmitted at lower resolution and fidelity. This can be directly translated to the modern use of NNs to generate either 3D objects or already rendered images of them.

The use of NNs to generate 3D objects is gaining some popularity lately, as for instance in the case of NeRFs (Neural Radiance Fields), one of the newest technologies to generate novel views of a 3D object by using a sparse group of images taken around it as a dataset to train a NN.

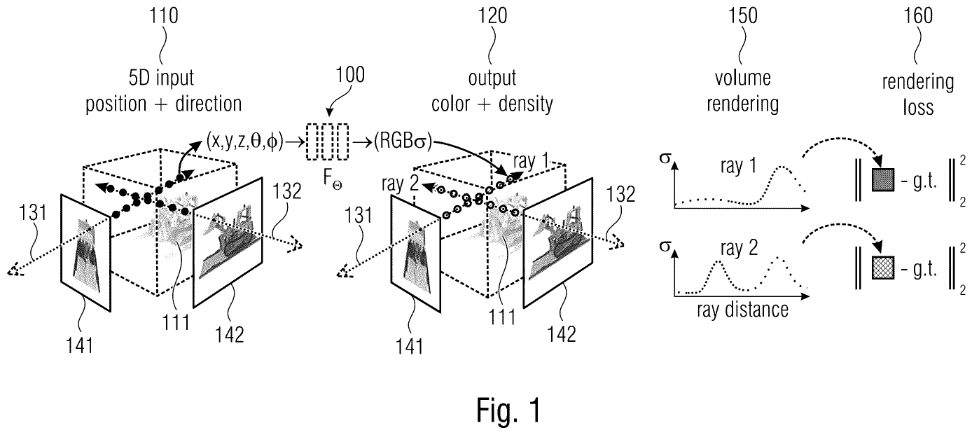

The working principle of NeRFs is illustrated in FIG. 1 and explained in more detail in the following section. Basically, an input 110 of a NeRF-trained NN 100 is a specific position (x, y, z) and viewing direction (θ, φ), while its output 120 is the most likely color and volume density of a point within/along a ray 131, 132 that goes through each pixel in a novel view 141, 142 showing a 3D object 111. The final rendered image of the 3D object 111 is the result of classic volumetric rendering techniques 150, i.e., to explain it in a simple way, the combination of several points within/along each of the rays 131, 132 corresponding to each of the pixels in that view 141, 142.

NeRFs aim at learning the characteristics of a 3D object 111 and minimizing the loss function that represents the difference between the sparse group of original images (ground truth) taken around the object and the corresponding image 141, 142 rendered by the NeRF. Typically, the loss corresponding to every image on the original dataset (ground truth) is given the same weight. This results in a final quality of the inferred images 141, 142 that is homogeneous and independent of the selected viewpoint.

However, as discussed above, this homogenous rendering quality needs a lot of computing resources because the 3D object 111 is rendered with the same (high) quality from each perspective/viewpoint of the user. For example, even though the user may currently look at the 3D object 111 from only one main perspective viewpoint (e.g., frontally looking at the front side of the object), even other perspective viewpoints (e.g., left/right, top, bottom or the back side of the object—which may not even be directly visible for the user currently looking at the front side) are rendered with the same (high) quality as the main perspective viewpoint (front side) of the user.

Thus, it is suggested to apply a viewpoint-dependent approach, in which a high (or highest) quality of the rendered images is applied to a main viewpoint of the user (e.g. frontal viewpoint), while other viewpoints (e.g., left/right, back side, top, bottom, etc.) may be rendered with lower qualities.

According to the present invention, a signaling scheme for signaling such a viewpoint-dependent neural network based rendering of a 3D object inside a scene is presented. Accordingly, the inventive method comprises a step of parsing rendering information from a scene description document. The inventive method further comprises a step of selecting one neural network out of a plurality of pre-trained neural networks for rendering the 3D object 111, wherein the pre-trained neural networks are each trained for rendering the 3D object 111 with different viewpoint-dependent representation qualities, wherein one or more of the neural networks comprises at least one (or exactly one) main viewpoint(s) from where the 3D object 111 is rendered with a highest representation quality. The parsed rendering information indicates the respective main viewpoint belonging to each neural network.

The present invention also concerns a respective apparatus configured to be used in a viewpoint-dependent rendering of a 3D object 111 in a scene, wherein the apparatus comprises a file parser configured to parse rendering information from a scene description document. The apparatus is configured to select one neural network out of a plurality of pre-trained neural networks for rendering the 3D object 111, wherein the pre-trained neural networks are each trained for rendering the 3D object 111 with different viewpoint-dependent representation qualities, wherein each neural network comprises at least one main viewpoint from where the 3D object 111 is rendered with a highest representation quality, and wherein the rendering information indicates the respective main viewpoint belonging to each neural network.

As will be described in more detail in the following sections, each neural network is configured to render the 3D object 111 from a plurality of different perspective viewpoints. Said plurality of different perspective viewpoints comprise the above mentioned (exactly) one or more main viewpoints with highest representation quality and one or more secondary viewpoints with a lower representation quality compared to the one or more main viewpoints.

At least one or each of the plurality of neural networks may comprises exactly one main viewpoint. Alternatively, at least one or each of the plurality of neural networks may comprise a set, e.g., a range, of main viewpoints, wherein each main viewpoint contained in the set may be associated with the same highest representation quality.

According to some embodiments, different neural networks may each comprise a different main viewpoint, or a different set of main viewpoints. For example, a first neural network may comprise a first main viewpoint (e.g., frontally looking at the front side of the 3D object), while a different second neural network may comprise a different second main viewpoint (e.g., looking at the back side of the 3D object). Accordingly, the different neural networks may be enabled to render the 3D object 111 from different main viewpoints with different viewpoint-dependent representation qualities. That is, the first neural network has a highest representation quality for its main viewpoint (e.g., frontally looking at the front side of the 3D object) while other viewpoints (e.g., back, left/right, top, bottom, etc.) may each have lower representation qualities than the main viewpoint. The second neural network has a highest representation quality for its main viewpoint (e.g., looking at the back side of the 3D object) while other viewpoints (e.g., front, left/right, top, bottom, etc.) may each have lower representation qualities than the main viewpoint.

The current perspective viewpoint of the user shall be permanently known, wherein the current perspective viewpoint is defined as the current relative position and orientation from where the user looks at the 3D object 111 to be rendered. As mentioned above, according to the herein described invention, a quality of the representation of the final rendered 3D object may vary depending on the current perspective viewpoint of the user, i.e., the invention provides for viewpoint-dependent representation qualities. The main viewpoint of the selected neural network (which should ideally correspond to the current perspective viewpoint from which the user looks at the 3D object) may be rendered with an emphasized quality compared to the remaining other secondary viewpoints.

Furthermore, the user may be equipped with a graphical user device, e.g., a camera, a VR/AR headset, a display, a handheld device, and the like. This graphical user device may be configured to present the final rendered image of the 3D object 111 to the user. For example, the user may wear a VR headset into which the representation of the final rendered 3D object 111 may be projected. The quality of the projected representation depends on the current perspective viewpoint of the user, i.e., the current direction from where the user looks at the 3D object.

In order to apply a viewpoint-dependent approach, as discussed within this document, a certain weight function may be applied to a training dataset of an NN. One of its views will be chosen as “main” or “main viewpoint” and, therefore, the losses corresponding to the images that are closest to it will be assigned higher weights than the ones that are further away, which will be given less importance. By following this approach, the quality of the generated novel view will vary depending on the distance to a particular main viewpoint leading to a viewpoint-dependent NeRF approach.

Therefore, in one of the applications and embodiments discussed in the following, a pre-trained NN (e.g., exactly one pre-trained NN) can be chosen from a collection/plurality of NNs that can render such a 3D object 111 by generating 2D images of variable qualities depending on the viewing direction from which the 3D object 111 is to be rendered. During training, each NN is assigned a specific emphasized view position, which is also referred to as a main perspective view or main viewpoint. In other words, the plurality of NNs may comprise different NNs each being associated with a different main perspective view.

In each case, those remaining secondary viewpoints that are closer to this specific “main” view position (i.e., main viewpoint) will be given higher weights (with respect to the loss that is being minimized in the NN). At the user/receiver side, the relative position between the user (e.g., camera) and each of the pre-defined emphasized view positions (i.e., main viewpoints) belonging to each of the NNs will be calculated. Then, the NN with the closest position with respect to the relative position between the camera (user) and the 3D object (that will also provide the highest rendering quality) will be chosen and transmitted.

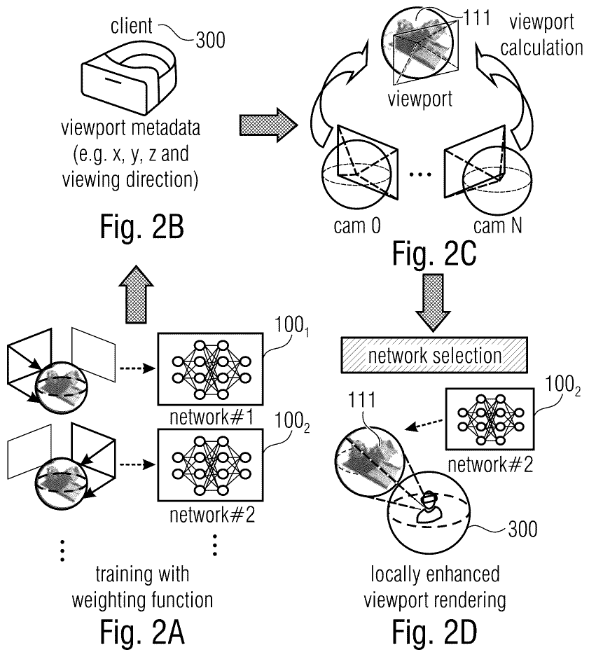

For such an approach to be feasible, appropriate information/signaling is provided as discussed in the following embodiments. An exemplary process according to an embodiment is shown in FIG. 2 which illustrates a training of each locally enhanced NN, and the NN selection for a viewpoint-dependent rendering. The following four steps are included in said process:
Derive/provide several NNs 100₁, 100₂ by training them to generate different emphasized qualities for a set of discrete pre-defined viewing positions (FIG. 2a).
Provide information/signaling to the client/user device 300 to describe the characteristics of such NNs (FIG. 2b).
Compute the relative position between the user/camera 300 and the 3D object 111 (FIG. 2c).
Select the NN 100₂ that has an emphasized viewing position as close as possible to the calculated relative position (FIG. 2d).

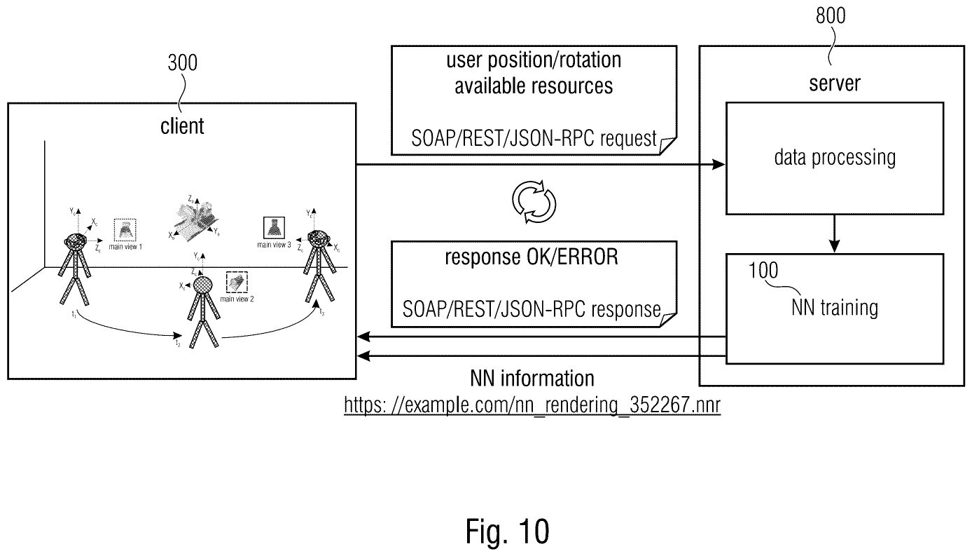

In real-time applications, instead of having a plurality of pre-trained NNs 100₁, 100₂ to choose among, a dynamic NN might be modified as required. As such, as discussed in some of the following embodiments, feedback mechanisms from the client to the server may be provided and the “sender” or “NN-generator” may provide new NNs or just updates thereof, e.g., in the form of differences to previous NNs. Such embodiments will be described somewhat later with reference to FIG. 10.

### Basic Concepts

In this section, several pieces of information about possible exemplary components of the invention are provided.

### NeRF (Neural Radiance Fields)

As a non-limiting example for a NN-based rendering technique in which the present invention can be applied, the so-called NeRF approach will be mentioned. However, it is contemplated that the present concept may also be applied to other NN-based rendering techniques.

As mentioned above with reference to FIG. 1, NeRF is a technique for representing and rendering 3D objects and/or scenes using a pre-trained NN 100. The NN 100 is trained to map 3D/5D coordinates 110 to scene properties 120, such as color and volume density. By optimizing parameters using training images, NeRF captures scene details and complex lighting effects. It can then generate realistic images from new viewpoints (so-called novel views) by ray marching through the learned 3D representation. NeRF is an effective method for image synthesis and virtual scene exploration.

The input 110 of the NN is a sparse set of 2D images 141, 142 of a 3D object or scene, wherein the 2D images show the 3D object from different perspective viewpoints that can be represented by the user's spatial location (x, y, z) and viewing direction (θ, φ). Once trained, the NN 100 is able to infer novel views (as 2D images) that were not present in the original dataset.

FIG. 1 shows this principle of NeRF with a description of the inputs 110 and outputs 120 of the NN in NeRF. In this example, a 3D object 111 in the form of a bulldozer shall be rendered. At the training process, for each pixel in each image 141, 142 of the training set (although a subset thereof can be chosen at each) a ray 131, 132 that crosses the pixel is computed. Then, the color and volumetric density of several points within/along the respective ray 131, 132 are learned. The results are summed up to compute the final color of the pixel. In order to train the NN 100, a rendering loss function is minimized (see 160), e.g., the MSE (Mean Squared Error) of the color of each pixel of the images in the training set against the color that results from summing up the output of the NN 100 for each point in the respective ray 131, 132.

NeRF was initially created as a viewpoint-independent NN graphic representation for static scenes with simple objects. This concept has evolved over time, allowing the inclusion of dynamic content, complex scenes, and manipulation of the elements in different ways, such as separating objects from the background. NeRF does not rely, initially, on an explicit 3D representation, even though it can provide depth information.

### Weighting Functions in NN-Based Rendering (e.g., NeRF)

Although known NN-based rendering techniques (e.g., NeRF) have typically been developed as viewpoint-independent mechanisms comprising a homogenous quality among each of its viewpoints, a viewpoint-dependent approach can be beneficial since known technologies often have high computational requirements and the use of heterogeneous weights can lead to a better distribution of the available resources. Thus, the present invention suggests such a viewpoint-dependent approach.

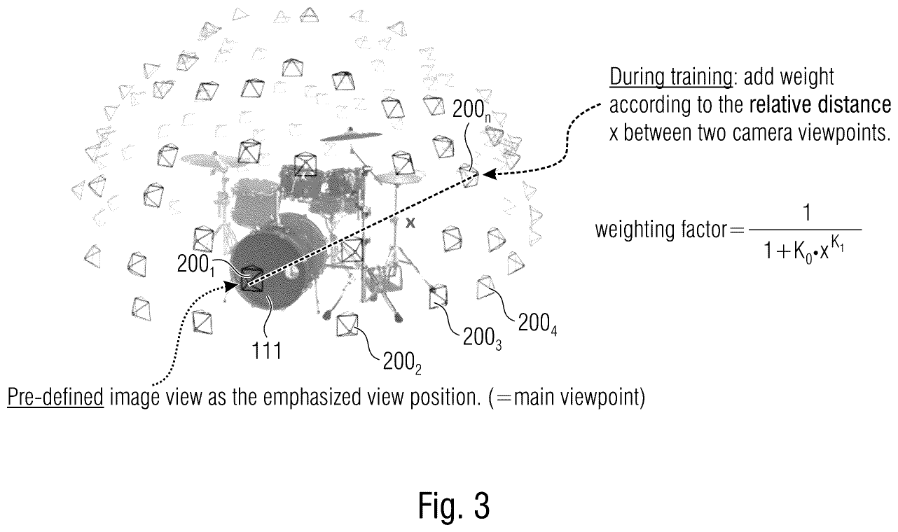

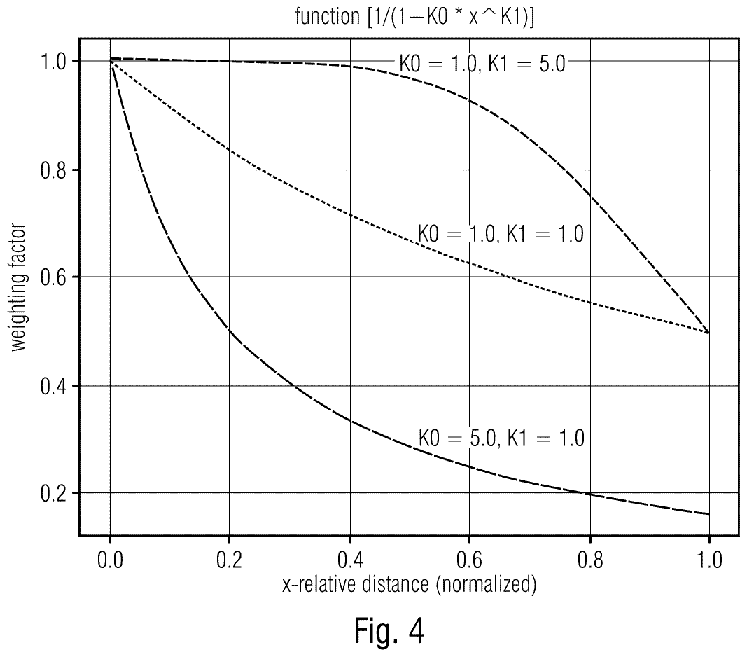

A way of achieving the inventive viewpoint-dependent NN-based rendering (e.g., NeRF) according to the present inventive concept, is to use a view-dependent loss function that incorporates a weighting factor based on the relative distance between any of the camera views present in the dataset and one pre-defined specific view that is chosen as “main” or “emphasized” (i.e., main viewpoint). The concept of a weighting mechanism in view-dependent NN-based rendering (e.g., NeRF) is illustrated in FIG. 3, where K0 and K1 are the hyperparameters used to manipulate the shape of the weighting factor curve. Some examples of different weighting curves are shown in FIG. 4.

FIG. 3 shows a 3D object 111 in the form of a drum set that is to be rendered. 2D images of the 3D object 111 are taken from different perspective viewpoints 200₁, 200₂, . . . , 200ₙ. Each black box in FIG. 3 corresponds to one perspective viewpoint 200₁, 200₂, . . . , 200ₙ.

Each of the NNs contained in the above mentioned plurality of NNs may be trained so as to comprise one main viewpoint (emphasized viewpoint) for which the respective NN provides the best rendering quality. In this non-limiting example, the rendering quality for a frontal view of the 3D object 111 shall be emphasized. Said frontal view corresponds to the perspective viewpoint labelled with 200₁. Accordingly, one NN will be specifically trained for a viewpoint-dependent rendering quality, wherein this particular perspective viewpoint 200₁ is selected as its (the NN's) main viewpoint. The main viewpoint 200₁ is rendered with a high quality, while the remaining secondary non-main viewpoints 200₂, 200₃, . . . , 200ₙ may be rendered with a lower rendering quality. Either all or only a subset of the remaining secondary non-main viewpoints 200₂, 200₃, . . . , 200ₙ may be rendered with a lower rendering quality.

Accordingly, each neural network 100₁, 100₂, . . . , 100ₙ is configured to render the 3D object 111 from a plurality of different perspective viewpoints 200₁, 200₂, . . . , 200ₙ, wherein said plurality of different perspective viewpoints 200₁, 200₂, . . . , 200ₙ comprise the at least one main viewpoint 200_{1A} having a highest representation quality and one or more secondary non-main viewpoints 200₂, . . . , 200ₙ having a lower representation quality compared to the at least one main viewpoint 200_{1A}.

As mentioned above, each neural network 100₁, 100₂, . . . , 100ₙ is configured/trained for rendering the 3D object 111 with viewpoint-dependent varying representation qualities among its one or more secondary non-main viewpoints 200₂, . . . , 200ₙ. That is, the rendering quality for the secondary non-main viewpoints 200₂, 200₃, . . . , 200ₙ may gradually decrease with increasing spatial distance from the respective main viewpoint 200₁. For example, secondary non-main viewpoint 200₂ is closer to the selected main viewpoint 200₁ than secondary non-main viewpoint 200₃. Thus, secondary non-main viewpoint 200₂ may be rendered with a higher quality than secondary non-main viewpoint 200₃.

According to the inventive principle, a signaling scheme is provided wherein information about the viewpoint-dependent rendering is contained in a scene description document. Said rendering information may comprise a descriptive indication about the above mentioned gradually decreasing representation quality, wherein said descriptive indication comprises at least one of
a descriptive indication how the representation quality gradually decreases,
a descriptive indication by which amount the representation quality gradually decreases, and
a descriptive indication how many and/or which secondary non-main viewpoints 200₂, . . . , 200ₙ are to be subjected to the gradually decreasing representation quality.

As mentioned above, the rendering quality depends on the spatial distance of a NN's secondary non-main viewpoints 200₂, . . . , 200ₙ relative to the NN's main viewpoint 200₁. The spatial distance from the main viewpoint 200₁ is schematically indicated in FIG. 3 by means of an arrow labelled with distance “x”. Taking into consideration the distance “x” of the camera viewpoint 200ₙ corresponding to a particular picture and the chosen main viewpoint 200₁, a different weighting factor will be applied to the MSE of the rays of the image within such distance x. This weighting factor will be integrated into the NeRF's photometric loss function, transforming the loss function into a weighted mean squared error (MSE):

$$\frac{{Σ}_{1}^{R} {W}_{R} \cdot {( {‖ {C}_{c} - C ‖}_{2}^{2} + ‖ {C}_{f} - C ‖ )}_{2}^{2}}{{Σ}_{1}^{R} {W}_{R}}$$

Where R indicates the fixed number of sampled rays used for mini-batch stochastic gradient descent training, C represents the ground truth RGB color, while C_{c} (color from a coarse network) and C_{f} (color from a fine network) denote the predicted RGB color from NeRF.

Experimentally, optimal values for K0 and K1 can be determined for a specific learning target, such as the drum kit 111 illustrated in FIG. 3. The weighting factor enhances the rendering quality of novel views close to the pre-defined emphasized/main viewpoint 200₁, as measured by PSNR (peak signal-to-noise ratio).

Accordingly, the inventive method and apparatus may be configured to train the plurality of different viewpoint-dependent neural networks, wherein, during training, the neural networks are configured/trained to minimize a loss function between 2D input images 141, 142 given as ground truth and one or more predicted 2D images. Said predicted 2D images correspond to the above discussed novel views of the 3D object 111.

The inventive apparatus may be configured to apply, during training of the neural networks, a viewpoint-dependent loss function by incorporating different weighting factors to the loss function, wherein the weighting factors depend on a relative distance between the respective main viewpoint 200_{1A} of the respective neural network that is to be trained and its remaining secondary non-main viewpoints 200₂, . . . , 200ₙ.

As discussed above, the weighting factors can be chosen such that the loss function for secondary non-main viewpoints 200₂, . . . , 200ₙ having a shorter distance to the main viewpoint 200_{1A} has a higher weight compared to other secondary non-main viewpoints 200₂, . . . , 200ₙ having a larger distance to the main viewpoint 200_{1A}. This results in a viewpoint-dependent rendering quality in which a higher rendering quality is applied to those secondary non-main viewpoints 200₂, . . . , 200ₙ having the shorter distance to the main viewpoint 200_{1A} compared to those other secondary non-main viewpoints 200₂, . . . , 200ₙ having the larger distance to the main viewpoint 200_{1A}.

Other methods could be used to get a similar viewpoint-dependent NeRF, where the training could be modified so that some secondary non-main viewpoints 200₂, 200₃, . . . , 200ₙ are better learned than others, without using the described weighting mechanism, e.g., including more rays of pictures having a shorter distance to the main viewpoint 200₁ than rays of pictures having a larger distance to the main viewpoint 200₁ at each iteration so that the learning process is adaptive or performing some kind of clustering with some pictures using a higher resolution than others.

Accordingly, in addition or alternatively to the above described weighting function, the inventive apparatus may be configured to determine, during training of the neural networks, for pixels contained in a 2D image 141, 142 in the training data set, a ray that crosses the respective pixel. Then, the apparatus may be configured to apply, still during training of the neural networks, a viewpoint-dependent training by including more rays per 2D image 141, 142 in secondary non-main viewpoints 200₂, . . . , 200ₙ having a shorter distance to the main viewpoint 200_{1A} compared to other secondary non-main viewpoints 200₂, . . . , 200ₙ having a larger distance to the main viewpoint 200_{1A}.

Yet further additionally or alternatively, 2D images with different image resolutions may be used for training the neural networks to the inventive view-dependent rendering approach. For example, the inventive apparatus may be configured to apply, during training of the neural networks, a viewpoint-dependent training by using 2D images 141, 142 with different image resolutions, wherein 2D images 141, 142 showing the 3D object 111 from a secondary non-main viewpoint 200₂, . . . , 200ₙ having a shorter distance to the main viewpoint 200_{1A} comprise a higher image resolution compared to other 2D images 141, 142 representing the 3D object 111 from a secondary non-main viewpoint 200₂, . . . , 200ₙ having a larger distance to the main viewpoint 200_{1A}.

In any case, the embodiments described herein apply to any form of viewpoint-dependent NN-based rendering techniques (e.g., NeRF), irrespective of how those have been generated.

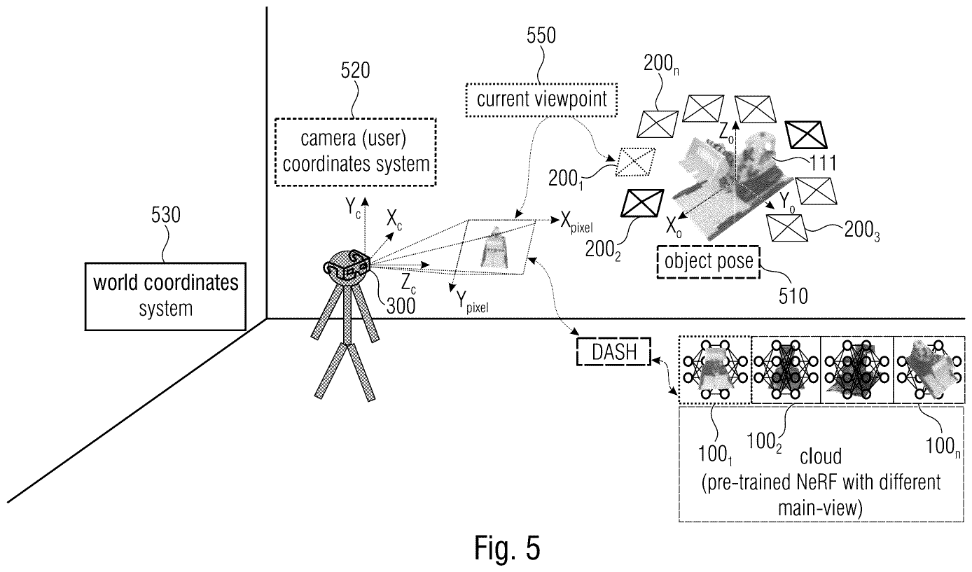

FIG. 5 shows a user device 300 being worn by a user. The user device 300 may comprise a VR/AR headset, for example. The user may look at a 3D object 111 to be rendered. As described above, the user may look at the 3D object 111 from different perspective viewpoints 200₁, 200₂, . . . , 200ₙ. According to the inventive concept, the current viewpoint 550 of the user 300 may be determined, which corresponds to the viewpoint (position and/or direction) from which the user/user device 300 currently looks at the 3D object 111 at a current time instant. Said current viewpoint 550 may also be referred to as a current viewing direction 550 from which the user may look at the 3D object 111. Accordingly, within this disclosure, the terms current viewpoint 550 and current viewing direction 550 may be used interchangeably. In case of a user device 300, e.g., a AR/VR headset, the current viewpoint 550 may also be referred to as a current viewport 550. Accordingly, within this disclosure, the terms current viewpoint 550 and current viewport 550 may be used interchangeably.

Based on the determined current viewpoint 550 of the user/user device 300, that one perspective viewpoint 200₁, 200₂, . . . , 200ₙ being close or closest to the determined current viewpoint 550 may be selected as the main viewpoint 200₁. In this case, a NN 100₁ out of a plurality of NNs 100₁, 100₂, . . . , 100ₙ can be selected that was trained with said selected perspective viewpoint 200₁ as its main viewpoint. Accordingly, the 3D object 111 may be rendered with a rendering quality that is enhanced/emphasized for this particular main viewpoint 200₁. The selected NN 100₁ may be configured to render the remaining secondary viewpoints 200₂, . . . , 200ₙ with lower representation qualities.

In some cases, the relative position between the user/user device 300 and the 3D object 111 may change over time. Accordingly, the user/user device 300 may look at the 3D object 111 from a different perspective viewpoint 200₁, 200₂, . . . , 200ₙ, i.e., the current viewpoint 550 of the user/user device 300 may change compared to the scenario described above. In this case, a different NN 100₁, 100₂, . . . , 100ₙ may be selected that was trained with a different main viewpoint being close or closest to the determined current viewpoint 550 of the user/user device 300.

### World and Camera Coordinate Systems in 3D Scenes

As exemplarily shown in FIG. 5, the world coordinate system 530 may be established during the initialization of the AR/VR/streaming applications. For instance, the origin of the world coordinate system 530 can be set as the camera center (user position) at the very first instant after the application startup. At this moment, the 3×3 rotation matrix R is an identity matrix: R=I₃, and the 3×1 translation matrix is t=0. On the other hand, the camera coordinate system 520 is related to the position of the viewpoint and moves together with it when the camera/user device 300 moves through the scene. Consequently, subsequent images and camera poses estimated by the AR/VR headset 300, denoted as R_{w}^{c} and t_{w}^{c}, refer to this initial image. These values can be utilized to transform the position of any 3D content 111 from the world coordinate system 530 to the camera coordinate system 520. FIG. 5 shows an example of this in the context of the invention.

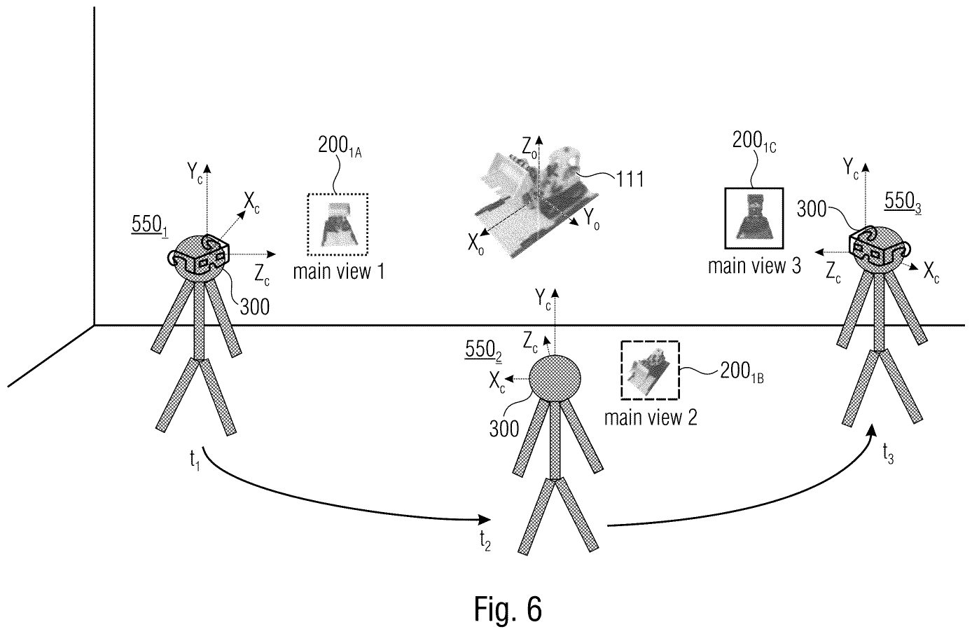

FIG. 6 shows a further example, where the user/user device 300 may move over time relative to the 3D object 111. At a first time instant t₁ the user/user device 300 may look from a first current viewpoint 550₁ at the 3D object 111. Accordingly, a NN being trained with a first main viewpoint 200_{1A} may be selected for viewpoint-dependent rendering of the 3D object 111 with an emphasized/enhanced quality for this respective first main viewpoint 200_{1A}.

At a second time instant t₂ the user/user device 300 may look from a different second current viewpoint 550₂ at the 3D object 111. Accordingly, a NN being trained with a second main viewpoint 200_{1B} may be selected for viewpoint-dependent rendering of the 3D object 111 with an emphasized/enhanced quality for this respective second main viewpoint 200_{1B}.

At a third time instant t₃ the user/user device 300 may look from a different third current viewpoint 550₃ at the 3D object 111. Accordingly, a NN being trained with a third main viewpoint 200_{1C} may be selected for viewpoint-dependent rendering of the 3D object 111 with an emphasized/enhanced quality for this respective third main viewpoint 200_{1C}.

When the 3D object 111 is virtually created in the scene and rendered for the first time in the 2D image space, the relative poses between the 3D object 111 and the camera (user) 300 can be easily described using the aforementioned coordinate systems 520, 530. In a simple scenario where the 3D object 111 remains fixed in the scene, the pose 510 of the 3D object 111 can always be transformed to the local camera coordinate system 520 or to the coordinate system of the 3D object 111 in real-time, using the R_{w}^{c} and t_{w}^{c} of the current camera poses as the user moves. In a more complex scenario where the 3D object 111 undergoes both translation and rotation, along with the user's movement, the object's pose 510 will be initially estimated with respect to the world origin 530. Then, it may be transformed to the local camera (user) coordinate system 520 for view-dependent rendering.

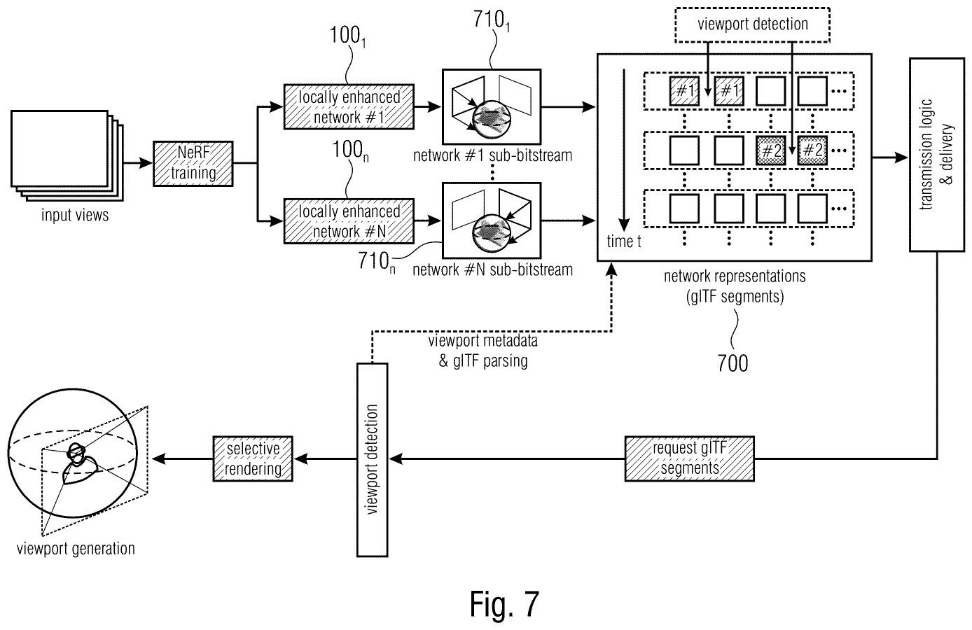

FIG. 7 shows a scenario for a viewpoint-dependent streaming architecture with a viewpoint-dependent rendering of a 3D object 111 inside a scene. A server may train a series/plurality of neural networks 100₁, . . . , 100ₙ that may emphasize each subspace. These neural networks 100₁, . . . , 100ₙ are responsible for rendering the same 3D object 111 or part of a scene, and each one is locally enhanced for viewpoint-dependent streaming scenarios. It is assumed that the user's gaze and position move through the stream at each time t, and the user's viewpoint 550 is detected accordingly so that the corresponding NN 100₁, . . . , 100ₙ is selected.

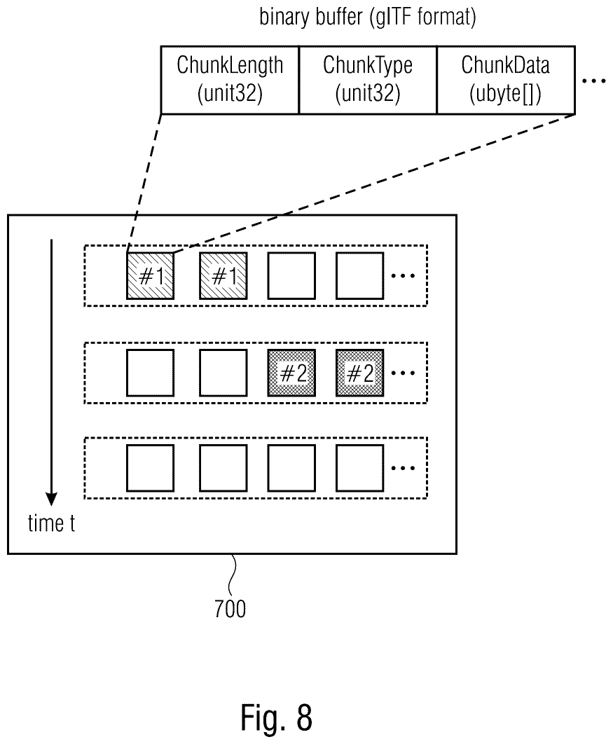

The object 111 could be a dynamic object that would change over time. In order to cope with the user's movements, several segments 700 corresponding to NNs 100₁, . . . , 100ₙ that represent the 3D object 111 for a particular time interval are made available to the user/user device 300. This is similar to typical Dynamic Adaptive Streaming over HTTP scenarios (DASH), where a video is offered in chunks of a few seconds. As such, the user/user device 300 may compute its current viewing position 550 and based thereon request the proper segment 700 (also see FIG. 8) containing an NN 100₁, . . . , 100ₙ (or an update thereof) that provides for the following time interval (e.g., for a few of seconds) a higher quality at a main viewpoint 200₁ close to the detected user viewing position 550.

Accordingly, the 3D object 111 may be represented in a bitstream that is partitioned into a plurality of sub-bitstreams 710₁, . . . , 710ₙ, wherein in each sub-bitstream 710₁, . . . , 710ₙ the 3D object 111 may be represented for a particular time interval, and wherein each sub bitstream 710₁, . . . , 710ₙ may be rendered by one out of a plurality of neural networks 100₁, . . . , 100ₙ each comprising at least one (or exactly one) main viewpoint. According to the invention, one out of the plurality of sub-bitstreams 710₁, . . . , 710ₙ may be selected between two consecutive time intervals, the selection being based on the current viewpoint (viewing direction) 550 of the user device 300.

According to an embodiment, that one out of the plurality of sub-bitstreams 710₁, . . . , 710ₙ is selected that is rendered by one neural network 100₁, . . . , 100ₙ comprising a main viewpoint being closest to the current viewpoint (viewing direction) 550 of the user device 300.

For this purpose, the camera's distance from the viewpoint is calculated, and this is mapped to the coordinate system 510 of the 3D object 111 so that a corresponding sub-bitstream 710₁, . . . , 710ₙ on the NN 100₁, . . . , 100ₙ is selected and sent to the client/user device 300 with additional transport logic. This allows for more efficient NeRF streaming by selectively rendering only the chosen NN 100₁, . . . , 100ₙ.

According to an embodiment, the current viewpoint 550 of the user 300 may have changed between two consecutive time intervals. In this case, a different main viewpoint 201_{1B} (c.f. FIG. 6) may be used in a subsequent sub-bitstream (belonging to the second time interval) compared to the previously presented sub-bitstream (corresponding to the first time interval).

According to a further embodiment, if the current viewpoint 550 of the user/user device 300 did not change between two consecutive time intervals, then the same main view point 201_{1A} (c.f. FIG. 6) as in the previously presented sub-bitstream can be used in a subsequent sub-bitstream.

Even though the inventive principle may be motivated by a NeRF that provides higher quality for viewpoints being closer to a selected main viewpoint 200₁ and worse quality for other secondary non-main viewpoints 200₂, . . . , 200ₙ (i.e. it is considered that the whole space can be used, i.e. the object can be rendered from any viewpoint albeit with a different quality), the embodiments also apply for the case that the viewpoint-dependent NeRF only renders an object 111 for a particular subset (e.g. only 200₅, 200₆, . . . , 200₁₂) of viewpoints close to the main viewpoint 200₁ and nothing for other viewpoints out of such a main viewpoint 200₁.

Accordingly, at least one or each neural network may be configured/trained for omit rendering one or more of the secondary viewpoints (e.g. 200₁₃, . . . , 200ₙ) that have a distance to the main viewpoint 200₁, which distance exceeds a predetermined threshold (e.g., only render up to secondary viewpoint 200₁₂).

As exemplarily depicted in FIG. 8, in the herein described streaming applications, viewpoint-dependent rendering may change over time due to the user's dynamic viewpoint 550₁, 550₂, 550₃ (c.f. FIG. 6). As the user's viewpoint 550₁, 550₂, 550₃ changes over time, the required segments 700 are computed according to the user's viewpoint information. For example, Segment #1 represents a locally enhanced NN 100₁ for #1 scene. If the user's viewpoint 550₁, 550₂, 550₃ changes to #2 scene, the required NN segment #2 will be transmitted. Each NN 100₁, . . . , 100ₙ is composed of several segments 700 over time, and the required segments 700 can be requested by the user/user device 300. Each of these segments 700 may be integrated according to the specifications of gITF.

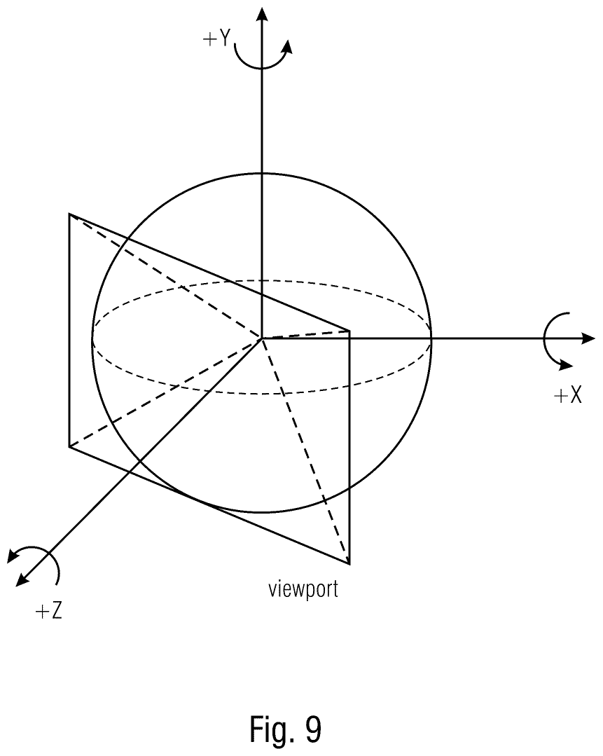

As depicted in FIG. 9, gITF uses a right-handed coordinate system. gITF defines +Y as up, +Z as forward, and −X as right the front of a gITF asset faces +Z.

Integration in the gITF Specification

In order to integrate the embodiments described above in the gITF specification, it is convenient to reuse existing elements in order to avoid unnecessary overhead in the JSON documents. To do this, the “MPEG_media” element, meant to serve as a description of dynamic data in a 3D scene, can be used. The “media” parameter will be filled with a list of references to the different sub-NNs to select from (each one being a NN where a different main view has been chosen). These NNs are listed by using a new MIME type named “application/nnr” and a URL that will contain the necessary definition of the NN.

Thus, according to some embodiments, the rendering information may comprise a list in which the sub-bitstreams 710₁, . . . , 710ₙ are provided and from which the user device 300 can choose. The list is filled with different entries containing a reference to different sub-bitstreams 710₁, . . . , 710ₙ. Each entry in the list may contain a different predefined transformation matrix that identifies the respective main viewpoints 200_{1A}, 200_{1B}, 200_{1c} belonging to each one of the respective sub-bitstreams 710₁, . . . , 710ₙ in said entry. Thus, the user device 300 may select one entry whose main viewpoint 200_{1A}, as indicated by the transformation matrix, is closest to a current viewpoint 550 of the user device 300.

Example 1 shows how to integrate the proposed method for the selection of the NN based on the time dependent TRS (Translation, Rotation and Scale) information of the object 111 in relation with the TRS of the camera 300. This is represented as a transformation matrix, included as one of the “extraParams” element that gITF already offers. As shown in the example, more than one NN are offered, each for a different main viewpoint (VP1 and VP2 in the example), with the associated matrix for identification of the main viewpoint.

```
{
    “asset“: {
      “generator”: “MPEG”,
      “version”: “2.0”
    },
    “scene”: 0,
    “scenes”: [
      {
          “nodes”: [0, 1]
      }
],
“nodes”: [
  {
        “mesh”: 0,
  },
  {
        “matrix”:[
```

| | | | |
|---|---|---|---|
| 2.0, | 0.0, | 0.0, | 0.0, |
| 0.0, | 0.866, | 0.5, | 0.0, |
| 0.0, | −0.25, | 0.433, | 0.0, |
| 10.0, | 20.0, | 30.0, | 1.0 |

```
        ]
        “extensions”: {
              “MPEG NN rendering”: {
```

“media”: 0

```
              }
        }
  }
],
    “MPEG_media”: {
          “media”: [
              {
                  “name”: “neural network rendering”,
                  “alternatives”: [
```

```
{
  “mimeType”: “application/nnr”,
  “uri”: https://example.com/nn_rendering_VP1.nnr
  “extraParams”: {
    “transform”: [
```

| | | | |
|---|---|---|---|
| 1.0, | 0.0, | 0.0, | 0.0, |
| 0.0, | 0.443, | 0.7, | 0.0, |
| 0.0, | −0.87, | 0.558, | 0.0, |
| 10.0, | 20.0, | 30.0, | 1.0 |

```
      ]
  }
},
{
  “mimeType”: “application/nnr”,
  “uri”: https://example.com/nn_rendering_VP2.nnr
  “extraParams”: {
      “transform”: [
```

| | | | |
|---|---|---|---|
| 1.0, | 0.0, | 0.0, | 0.0, |
| 0.0, | −0.87, | 0.558, | 0.0, |
| 0.0, | 0.443, | 0.7, | 0.0, |
| 10.0, | 20.0, | 30.0, | 1.0 |

```
      ]
  },
}
{
  ...
},
```

```
                    ]
                }
            ]
      }
  }
}
```

### Example 1: GITF File with a Transformation Matrix Associated to Each NN

Thus, according to Example 1 above, the parsed rendering information may comprise a list in which the sub-bitstreams 710₁, . . . , 710ₙ are provided and from which the user device 300 can choose, wherein the list is filled with different entries containing a reference to different sub-bitstreams 710₁, . . . , 710ₙ.

According to an embodiment, each entry in the list may contain a different predefined transformation matrix that identifies the respective main viewpoint belonging to the respective sub-bitstream in said entry. The user device 300 may be configured to select that one entry whose main viewpoint, as indicated by the transformation matrix, is closest to the current viewpoint 500 of the user device 300.

As previously discussed with reference to FIGS. 5 and 6 the position of the 3D object 300 may be defined in a world coordinate system 530, wherein the above mentioned pre-defined transformation matrix (Example 1), that identifies the respective main viewpoint, refers to an object coordinate system where the origin is at the position of the 3D object 111. In this case, the current viewpoint 550 of the user device 300 may be determined in the object coordinate system.

According to an embodiment, the current viewpoint 550 of the user device 300 may be transformed from the world coordinate system 530 into the object coordinate system taking into account the current position of the 3D object 111 in the world coordinate system 530.

Apart from the above discussed transform matrix, other alternatives can be used in order to specify the relative position of the camera 300 relative to the 3D object 111. If we directly use the local coordinate system 510 of the object 111, it is possible to describe the position of the camera 300 with a vector that contains just the x, y and z coordinates in that system. Regarding the viewing direction, it can be considered that the camera 300 will always look at the object 111. Example 2 illustrates this possibility.

```
{
      “asset“: {
        “generator”: “MPEG”,
        “version”: “2.0”
      },
      “scene”: 0,
      “scenes”: [
        {
            “nodes”: [0, 1]
        }
],
“nodes”: [
  {
          “mesh”: 0,
  },
  {
          “matrix”: [
```

| | | | |
|---|---|---|---|
| 2.0, | 0.0, | 0.0, | 0.0, |
| 0.0, | 0.866, | 0.5, | 0.0, |
| 0.0, | −0.25, | 0.433, | 0.0, |
| 10.0, | 20.0, | 30.0, | 1.0 |

```
          ]
          “extensions”: {
                  “MPEG NN rendering”: {
```

“media”: 0

```
                  }
          }
  }
],
      “MPEG_media”: {
            “media”: [
                  {
                    “name”: “neural network rendering”,
                    “alternatives”: [
```

```
{
  “mimeType”: “application/nnr”,
  “uri”:
      https://example.com/nn_rendering_VP1.nnr
  “extraParams”: {
        “position”: [
```

| | |
|---|---|
| 0.44, | 1.20, 3.87 |

```
        ]
  }
},
{
  “mimeType”: “application/nnr”,
  “uri”:
      https://example.com/nn_rendering_VP2.nnr
  “extraParams”: {
        “position”: [
```

| | |
|---|---|
| 0.21, | 1.77, 3.99 |

```
        ]
  },
{
    ...
},
```

```
                      ]
                    }
                ]
          }
    }
}
```

### Example 2: GITF File with a Position Vector Associated to Each NN

Thus, according to Example 2 above, the parsed rendering information may comprise a list in which the sub-bitstreams 710₁, . . . , 710ₙ are provided and from which the user device 300 can choose, wherein the list is filled with different entries containing a reference to different sub-bitstreams 710₁, . . . , 710ₙ.

According to an embodiment, each entry in the list may contain a different pre-defined one-dimensional position vector that identifies the respective main viewpoints 200_{1A}, 200_{1B}, 200_{1c} belonging to each of the respective sub-bitstreams 710₁, . . . , 710ₙ in said entry. The user device 300 may be configured to select one entry whose main viewpoint 200_{1A}, as indicated by the pre-defined one-dimensional position vector, is closest to the current viewpoint 500 of the user device 300.

As previously discussed with reference to FIGS. 5 and 6 the position of the 3D object 300 may be defined in a world coordinate system 530, wherein the above mentioned pre-defined one-dimensional position vector (Example 2), that identifies the respective main viewpoint 200_{1A}, refers to an object coordinate system where the origin is at the position of the 3D object 111. In this case, the current viewpoint 550 of the user device 300 may be determined in the object coordinate system.

According to an embodiment, the current viewpoint 550 of the user device 300 may be transformed from the world coordinate system 530 into the object coordinate system taking into account the current position of the 3D object 111 in the world coordinate system 530.

### Aspect: Real-Time-Feedback Scenario

The embodiments described above are also compatible with real-time dynamic scenarios, an example of which is depicted in FIG. 10. For example, a client 300 may provide a server 800 with information about the current state of the scene (the position/rotation of the camera/user 300, available resources . . . ). The NN 100 used in this scenario may not be pretrained, or just an initial version of it will be pretrained. Therefore, the server 800 will be in charge of using the feedback received from the client 300 for training or retraining a NN 100. After doing so, this NN 100 or just a delta of it (difference to the previously sent NN) will be sent by the server 800. Information about just one single NN 100 will be received by the client 300 (instead of a list of alternatives, as in the previous cases).

According to an embodiment, a method for real-time viewpoint-dependent rendering of a 3D object 111 is suggested. The method comprises a step of determining a current viewpoint (viewing direction) 550 of a user device 300, wherein said current viewpoint 550 may change over time. As mentioned above, the viewpoint 550 may be defined as a position and/or orientation from where the user device 300 looks at the 3D object 111 to be rendered.

According to this real-time embodiment an updatable dynamic neural network 100 may be used for rendering the 3D object 111 with different viewpoint-dependent representation qualities depending on the current viewpoint 550 of the user device 300, wherein the dynamic neural network 100 comprises one or more main viewpoints 200_{1A}, 200_{1B}, 200_{1C} from where the 3D object 111 is rendered with a highest representation quality. The inventive dynamic neural network 100 is configured to be updated in order to provide new one or more main viewpoints 200_{1A}, 200_{1B}, 200_{1C} between two consecutive time instants. For example, at a first time instant t₁, the neural network 100 may comprise a first main viewpoint 200_{1A}. At a subsequent second time instant t₂, the neural network 100 may be updated so that it comprises a different second main viewpoint 200_{1B}. Changing/updating the main viewpoints 200_{1A}, 200₁B may be necessary if the current viewpoint (viewing direction) 550 of the user device 330 may have changed between two consecutive time intervals t₁, t₂.

As mentioned above, the dynamic neural network 100 may be configured to be updated in response to a reported feedback information from the user device 300. The reported feedback may comprise at least the current viewpoint 550 of the user device 300. The current viewpoint 550 of the user device 300 may be reported to the server 800 in a message being transmitted either continuously or with a predetermined periodicity.

The reported feedback information may comprise an indication about currently available resources of the user device 300, such as available memory, which allows to estimate a highest possible rendering quality for the main viewpoint 200₁, as well as best possible lower rendering qualities for the other secondary non-main viewpoints 200₂, . . . , 200ₙ. Rendering quality may, for instance, be quantified by image resolution. For example, the higher the image resolution the higher the rendering quality. Thus, according to some embodiments, the reported feedback information may comprise an indication about a desired resolution of the representation of the 3D object 111.

According to an embodiment, the updateable dynamic neural network 100 may be updated by replacing the previous version of the dynamic neural network 100 with a complete new version of the dynamic neural network 100 and providing the complete new version of the dynamic neural network 100 to the user device 300.

In this embodiment, the dynamic neural network 100 may be retrained by using the reported feedback information resulting in the complete new version of the dynamic neural network 100 which comprises the above mentioned new one or more main viewpoints 200_{1A}, 200_{1B}, 200_{1C}.

According to an alternative embodiment, the updateable dynamic neural network 100 may be updated by calculating a delta value that describes a difference to the previously used version of the dynamic neural network 100, wherein said delta value may be provided/transmitted to the user device 300.

In this alternative embodiment, the dynamic neural network 100 may be partially retrained using the reported feedback information, wherein the delta value is obtained as a result of the partial retraining.

Typically, real-time communication scenarios rely on RTP/UDP transport and perform some session negotiation beforehand to exchange information about capabilities and how the session is going to be transmitted, e.g. using the Session Description Protocol (SDP). As such, according to an embodiment, the sender 800 and user 300 may exchange some negotiation (e.g., using SDP) in which an “updatable” NN 100 is negotiated. The sender 800 of the NN 100 includes capability information for the user 300 to accept it, as for instance complexity of the NN 100, viewpoint-range for which the NN 100 can be used to render an object 111 (e.g., if not every viewpoint can be rendered), quality information about the rendered content (assuming there is an emphasized viewport for which the NN 100 produces a higher quality) or the fact that the receiver 300 might send feedback mechanism about its position, viewing direction, interaction information that could move the output of the NN 100 to another position, etc. In such a scenario, typically the user 300 would send the feedback using RTCP messages with a particular periodicity. After receiving such a feedback the sender 800 could provide the receiver 300 with an updated NN 100.

Thus, according to an embodiment, the dynamic neural network 100 may be provided by a sender device (e.g. a NN generator, a server, a NN provider, etc.) 800, wherein the inventive method comprises a step of performing a session negotiation between the sender device 800 and the user device 300 to exchange session information about capabilities and/or how the session is going to be transmitted. The inventive method may further comprise a step of exchanging session information between the sender device 800 and the user device 300 in which a usage of the updatable dynamic neural network 100 is negotiated.

The exchanged session information may comprise at least one of:
an information about a complexity of the dynamic neural network 100,
an information about a viewpoint-range in which the dynamic neural network 100 can be used for rendering the 3D object 111,
an information about a viewpoint range in which the dynamic neural network 100 provides the same emphasized quality for its main perspective viewpoint and for a set of surrounding second viewpoints,
an information that the dynamic neural network 100 offers a viewpoint-dependent rendering of the 3D object 111 with a viewpoint-dependent representation quality,
an information about the dynamic neural network 100 using a single main viewpoint for the viewpoint-dependent rendering,
an information about the dynamic neural network 100 using a range of main viewpoints for the viewpoint-dependent rendering,
an information about a rendering quality depending on the current viewpoint 550 of the user device 300,
an information about an overall quality of the rendered content,
an information about the fact that the user device 300 is capable of providing its current viewpoint 550 at different time instances,
an information about the fact that the user device 300 is capable of providing its current viewing direction at different time instances, and
an information about an interaction that triggers the update process of the dynamic neural network 100.

The above mentioned feedback could also be sent “continuously” to the server 800. This means that the periodicity with which the messages are sent from the client 300 may depend on certain technical aspects of the system, such as the framerate that is used to render the scene (the feedback would be sent once per frame) or the performance capabilities of the client 300 and the server 800 (the feedback is sent as often as possible). In this case, the server 800 would quickly adapt/retrain the NN 100 to match the current conditions of the scene.

There could be other means to send the feedback from the client 300 to the server 800. Apart from using RTCP, any API protocol could be used, such as SOAP, REST, JSON-RPC or gRPC. Besides this, although described that the NN 100 is trained after receiving feedback, multiple NNs could be pre-trained and sent back over time based on the received feedback.

FIG. 10 shows the flow of information in the real-time scenario. The server 800 may retrain the NN 100 with the updated information and will update the gITF document with a pointer to the new NN 100, trained for a specific time instant. In Example 3 below, the ID 352267 refers to this time instant.

Thus, according to an embodiment, the one or more main viewpoints 200_{1A}, 200_{1B}, 200_{1C} of the dynamic neural network 100 may be described in a scene description document, wherein after the dynamic neural network 100 has been updated, the scene description document is also updated by including a reference to the updated version of the dynamic neural network 100.

Another option, if the synchronization is guaranteed, is to use a generic URL for the NN 100. When the user accesses this URL, the latest version of the NN 100 will be provided. In this case, there is no need to update the URL in the gITF document.

Thus, according to a further embodiment, the scene description document may contain a generic address and/or a generic reference under which the latest version of the updatable dynamic neural network 100 is accessible, wherein after the dynamic neural network 100 has been updated, the updated version of the dynamic neural network 100 is to be retrieved under said generic address.

The above mentioned feedback information that the client 300 will send to the server 800 includes its position/rotation with respect to the 3D object 111 that is to be rendered. Other pieces of information, such as an indication of the currently available resources or the desired resolution for the rendered image can appear in the feedback messages as well. The Example 3 shows an example of a JSON-RPC request message.

```
{
  “method”: “retrainNN”,
  “id”: “352267”
  “params”: [
```

| | | |
|---|---|---|
| posX, | posY, | posZ |
| rotX, | rotY, | rotZ |

resolutionWidth, resolutionHeight,

...

]
}

### Example 3: JSON-RPC Request Sent by the Client

According to the present invention, the updatable neural network 100 may be configured to provide a view-dependent rendering approach, as described above. Accordingly, the inventive updatable dynamic neural network is configured to render the 3D object 111 from a plurality of different perspective viewpoints 200₁, 200₂, . . . , 200ₙ, said plurality of different perspective viewpoints 200₁, 200₂, . . . , 200ₙ comprising a currently used main viewpoint 200₁ having a highest representation quality and one or more secondary non-main viewpoints 200₂, . . . , 200ₙ having a lower representation quality compared to the main viewpoint 200₁.

As described above, as part of the inventive concept of a viewpoint-dependent rendering approach, the rendering quality may gradually decrease with increasing distance from a chosen main viewpoint 200₁. Thus, according to some embodiments, the updatable dynamic neural network 100 may be configured/trained for rendering the 3D object 111 with a representation quality that gradually decreases with increasing distance from its currently used main viewpoint 200₁, wherein secondary non-main viewpoints 200₂, . . . , 200ₙ having a shorter distance to the currently used main viewpoint 200₁ are rendered with a higher representation quality than other secondary non-main viewpoints 200₂, . . . , 200ₙ having a larger distance to the currently used main viewpoint 200₁.

The present invention further concerns an apparatus to be used in real-time viewpoint-dependent rendering of a 3D object (111), as described above. The inventive apparatus may be configured to determine a current viewpoint 550 of a user device 300, wherein said viewpoint 550 may change over time, wherein the current viewpoint 550 is defined as a position and/or orientation from where the user device 300 looks at the 3D object 111 to be rendered. The apparatus may further be configured to use an updatable dynamic neural network 100 for rendering the 3D object 111 with different viewpoint-dependent representation qualities depending on the current viewpoint 550 of the user device 300. The dynamic neural network 100 comprises at least one main viewpoint 200_{1A} from where the 3D object 111 is rendered with a highest representation quality. The dynamic neural network 100 may further be configured to be updated in order to provide a new main viewpoint 200_{1B} between two consecutive time instants t₁, t₂.

Although some aspects have been described in the context of a method, it is clear that these aspects also represent a description of a corresponding apparatus for performing said method, wherein a method step or a feature of a method step corresponds to a block or item or feature of the corresponding apparatus. Analogously, aspects described in the context of an apparatus also represent a description of a corresponding method step of a corresponding method.

Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments comprise a data carrier having electronically readable control signals, which are capable of cooperating with a programmable computer system, such that one of the methods described herein is performed.

Generally, embodiments can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

Mildenhall, Ben, et al. “NeRF: Representing Scenes as Neural Radiance Fields for View Synthesis.” Computer Vision-ECCV 2020: 16th European Conference, Glasgow, UK, Aug. 23-28, 2020, Proceedings, Part I 16. Springer International Publishing, 2020.

1. An apparatus to be used in a viewpoint-dependent rendering of a 3D object (111) in a scene, wherein the apparatus comprises:
a file parser configured to parse rendering information from a scene description document,
wherein the apparatus is configured to select one neural network (100₁) out of a plurality of pre-trained neural networks (100₁, 100₂, . . . , 100ₙ) for rendering the 3D object (111), wherein the pre-trained neural networks (100₁, 100₂, . . . , 100ₙ) are each trained for rendering the 3D object (111) with different viewpoint-dependent representation qualities, wherein each neural network (100₁, 100₂, . . . , 100ₙ) comprises at least one main viewpoint (200_{1A}) from where the 3D object (111) is rendered with a highest representation quality,
wherein the rendering information indicates the respective main viewpoint (200_{1A}) belonging to each neural network (100₁, 100₂, . . . , 100ₙ), and
wherein the selection of the one neural network (100₁) is based on a current viewpoint (550) of a user device (300), said current viewpoint (550) being defined as a position and/or orientation from where the user device (300) currently looks at the 3D object (111).

2. The apparatus according to claim 1,
wherein each neural network (100₁, 100₂, . . . , 100ₙ) comprises a set of main viewpoints (200_{1A}, 200_{1B}, 200_{1c}), each main viewpoint contained in the set (200_{1A}, 200_{1B}, 200_{1c}) being associated with the same highest representation quality, and/or
wherein different neural networks (100₁, 100₂, . . . , 100ₙ) each comprise a different main viewpoint (200_{1A}, 200_{1B}, 200_{1c}), or a different set of main viewpoints, such that the different neural networks (100₁, 100₂, . . . , 100ₙ) are configured to render the 3D object (111) from different main viewpoints (200_{1A}, 200_{1B}, 200_{1c}) having viewpoint-dependent representation qualities.

3. The apparatus according to claim 1,
wherein each neural network (100₁, 100₂, . . . , 100ₙ) is configured to render the 3D object (111) from a plurality of different perspective viewpoints (200₁, 200₂, . . . , 200ₙ),
said plurality of different perspective viewpoints (200₁, 200₂, . . . , 200ₙ) comprising the at least one main viewpoint (200_{1A}) with a highest representation quality and one or more secondary non-main viewpoints (200₂, . . . , 200ₙ) with a lower representation quality compared to the at least one main viewpoint (200_{1A}).

4. The apparatus according to claim 3,
wherein each neural network (100₁, 100₂, . . . , 100ₙ) is configured/trained for rendering the 3D object (111) with viewpoint-dependent varying representation qualities among its one or more secondary non-main viewpoints (200₂, . . . , 200ₙ), and/or
wherein each neural network (100₁, 100₂, . . . , 100ₙ) is configured/trained for rendering the 3D object (111) with a representation quality that gradually decreases with increasing distance from its main viewpoint (200_{1A}), wherein secondary non-main viewpoints (200₂) having a shorter distance to the main viewpoint (200_{1A}) are rendered with a higher representation quality than other secondary non-main viewpoints (200₃) having a larger distance to the main viewpoint (200_{1A}).

5. The apparatus according to claim 4,
wherein the rendering information comprises a descriptive indication about the gradually decreasing representation quality, wherein said descriptive indication comprises at least one of:
a descriptive indication how the representation quality gradually decreases,
a descriptive indication by which amount the representation quality gradually decreases, and
a descriptive indication how many and/or which secondary non-main viewpoints (200₂, . . . , 200ₙ) are to be subjected to the gradually decreasing representation quality.

6. The apparatus according to claim 3,
wherein each neural network (100₁, 100₂, . . . , 100ₙ) is configured/trained for omit rendering one or more of the secondary non-main viewpoints (200₂, . . . , 200ₙ) that have a distance to the main viewpoint (200_{1A}), which distance exceeds a predetermined threshold.

7. The apparatus according to claim 1,
wherein the viewpoint-dependent rendering of the 3D object (111) is based on a set of 2D images (141, 142) of the 3D object (111), the set of 2D images (141, 142) comprising training images and novel views of the 3D object (111),
wherein the training images are used to train the neural networks (100₁, 100₂, . . . , 100ₙ), and wherein the novel views are generated by the neural networks (100₁, 100₂, . . . , 100ₙ), and/or
wherein the neural networks (100₁, 100₂, . . . , 100ₙ) are configured to use the Neural Radiance Field—NeRF—technology, wherein the neural networks (100₁, 100₂, . . . , 100ₙ) are trained with a training data set comprising a sparse set of 2D input images (141, 142) as ground truth taken from different spatial perspective viewpoints of the 3D object (111), and wherein the neural networks (100₁, 100₂, . . . , 100ₙ) are configured to generate additional 2D novel views of the 3D object (111) based on the training data set.

8. The apparatus according to claim 1,
wherein, during training, the neural networks (100₁, 100₂, . . . , 100ₙ) are configured/trained to minimize a loss function between 2D input images (141, 142) given as ground truth and one or more predicted 2D images.

9. The apparatus according to claim 8,
wherein the apparatus is configured to apply, during training of the neural networks (100₁, 100₂, . . . , 100ₙ), a viewpoint-dependent loss function by incorporating different weighting factors to the loss function,
wherein the weighting factors depend on a relative distance between the respective main viewpoint (200_{1A}) of the respective neural network (100₁, 100₂, . . . , 100ₙ) that is to be trained and its remaining secondary non-main viewpoints (200₂, . . . , 200ₙ),
wherein the weighting factors are chosen such that the loss function for secondary non-main viewpoints (200₂, . . . , 200ₙ) having a shorter distance to the main viewpoint (200_{1A}) has a higher weight compared to other secondary non-main viewpoints (200₂, . . . , 200ₙ) having a larger distance to the main viewpoint (200_{1A}),
resulting in a viewpoint-dependent rendering quality in which a higher rendering quality is applied to those secondary non-main viewpoints (200₂, . . . , 200ₙ) having the shorter distance to the main viewpoint (200_{1A}) compared to those other secondary non-main viewpoints (200₂, . . . , 200ₙ) having the larger distance to the main viewpoint (200_{1A}).

10. The apparatus according to claim 9,
wherein the viewpoint-dependent loss function is calculated according to
$$\frac{{Σ}_{1}^{R} {W}_{R} \cdot {( {‖ {C}_{c} - C ‖}_{2}^{2} + ‖ {C}_{f} - C ‖ )}_{2}^{2}}{{Σ}_{1}^{R} {W}_{R}}$$
wherein R indicates the fixed number of sampled rays used for mini-batch stochastic gradient descent training, C represents the ground truth RGB color, while Cc (RGB color coarse) and Cf (RGB color fine) denote the predicted RGB color of the trained neural networks (100₁, 100₂, . . . , 100ₙ).

11. The apparatus according to claim 1,
wherein the apparatus is configured to determine, during training of the neural networks (100₁, 100₂, . . . , 100ₙ), for pixels contained in a 2D image (141, 142) in the training data set, a ray that crosses the respective pixel, and apply, during training of the neural networks (100₁, 100₂, . . . , 100ₙ), a viewpoint-dependent training by including more rays per 2D image (141, 142) in secondary non-main viewpoints (200₂, . . . , 200ₙ) having a shorter distance to the main viewpoint (200_{1A}) compared to other secondary non-main viewpoints (200₂, . . . , 200ₙ) having a larger distance to the main viewpoint (200_{1A}), and/or
wherein the apparatus is configured to apply, during training of the neural networks (100₁, 100₂, . . . , 100ₙ), a viewpoint-dependent training by using 2D images (141, 142) with different image resolutions, wherein 2D images (141, 142) representing the 3D object (111) from a secondary non-main viewpoint (200₂, . . . , 200ₙ) having a shorter distance to the main viewpoint (200_{1A}) comprise a higher image resolution compared to other 2D images (141, 142) representing the 3D object (111) from a secondary non-main viewpoint (200₂, . . . , 200ₙ) having a larger distance to the main viewpoint (200_{1A}).

12. The apparatus according to claim 1,
wherein the 3D object (111) is represented in a bitstream that is partitioned into a plurality of sub-bitstreams (710₁, . . . , 710ₙ), wherein in each sub-bitstream (710₁, . . . , 710ₙ) the 3D object (111) is represented fora particular time interval, and wherein each sub-bitstream (710₁, . . . , 710ₙ) is rendered by a neural network (100₁, 100₂, . . . , 100ₙ) comprising at least one main viewpoint (201_{1A}), and
wherein the apparatus is configured to select one out of the plurality of sub-bitstreams (710₁, . . . , 710ₙ) between two consecutive time intervals, the selection being based on a current viewpoint (550) of a user device (300).

13. The apparatus according to claim 12,
wherein the apparatus is configured to select that one out of the plurality of sub-bitstreams (710₁, . . . , 710ₙ) that is rendered by a neural network (100₁, 100₂, . . . , 100ₙ) comprising a main viewpoint (200_{1A}) being closest to a current viewpoint (550) of the user device (300).

14. The apparatus according to claim 12,
wherein
if the current viewpoint (550) of the user device (300) did not change between the two consecutive time intervals,
then the apparatus is configured to use the same main view point (200_{1A}) as before in a subsequent sub-bitstream (710₁, . . . , 710ₙ), or
if a change in the current viewpoint (550) of the user device (300) happened between the two consecutive time intervals,
then the apparatus is configured to use a different main viewpoint (200_{1B}) than before in a subsequent sub-bitstream (710₁, . . . , 710ₙ).

15. The apparatus according to claim 12,
wherein the rendering information comprises a list in which the sub-bitstreams (710₁, . . . , 710ₙ) are provided and from which the user device (300) can choose, wherein the list is filled with different entries containing a reference to different sub-bitstreams (710₁, . . . , 710ₙ).

16. The apparatus according to claim 15,
wherein each entry in the list contains a different predefined transformation matrix that identifies the respective main viewpoints (200_{1A}, 200_{1B}, 200_{1c}) belonging to each of the respective sub-bitstreams (710₁, . . . , 710ₙ) in said entry, and
wherein the user device (300) is configured to select one entry whose main viewpoint (200_{1A}), as indicated by the transformation matrix, is closest to a current viewpoint (550) of the user device (300).

17. The apparatus according to claim 16,
wherein the position of the 3D object (111) is defined in a world coordinate system (530), and wherein the pre-defined transformation matrix that identifies the respective main viewpoint (200_{1A}) refers to an object coordinate system where the origin is at the position of the 3D object (111).

18. The apparatus according to claim 15,
wherein each entry in the list contains a pre-defined one-dimensional position vector that identifies the respective main viewpoints (200_{1A}, 200_{1B}, 200_{1c}) belonging to each of the respective sub-bitstreams (710₁, . . . , 710ₙ) in said entry, and
wherein the user device (300) is configured to select one entry whose main viewpoint (200_{1A}), as indicated by the one-dimensional position vector, is closest to a current viewpoint (550) of the user device (300).

19. The apparatus according to claim 18,
wherein the position of the 3D object (111) is defined in a world coordinate system (530), and
wherein the pre-defined one-dimensional position vector that identifies the respective main viewpoint (200_{1A}) refers to an object coordinate system where the origin is at the position of the 3D object (111).

20. The apparatus according to claim 19,
wherein the current viewpoint (550) of the user device (300) is determined in the object coordinate system, and
wherein the current viewpoint (550) of the user device (300) is transformed from the world coordinate system (530) into the object coordinate system taking into account the current position of the 3D object (111) in the world coordinate system (530).
